(19) United States
(12) Patent Application Publication
(10) Pub. No.: US 2007/0203766 A1
(43) Pub. Date: Aug. 30, 2007

(54) Process framework and planning tools for aligning strategic capability for business transformation

(75) Inventors: Gary Adler, Teaneck, NJ (US); Timmy L. Collins, Red Lion, PA (US); Calvin L. Doss II, Raleigh, NC (US); Stephen B. Piper, Warren, RI (US); Billy H. Thompson, Cary, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/363,310

(22) Filed: Feb. 27, 2006

(51) Int. Cl. G06F 9/44

(52) U.S. Cl. 705/7

(57) ABSTRACT

A business transformation alignment framework and toolset. A system is disclosed that includes: a data interface system for storing and displaying business transformation data categorized into initiative data, capability data and IT requirement data; a mapping system for mapping between initiative data, capability data and IT requirement data; and a dashboard interface for displaying alignment analysis information regarding how well a set of IT requirements aligns with a capability defined to address a business transformation objective.

### FIELD OF THE INVENTION

The invention relates generally to managing business strategies, and more particularly, to a process framework and planning tools for aligning capabilities to achieve business transformation.

### BACKGROUND OF THE INVENTION

In today's technology driven business environment, business enterprises must continually evolve their business strategies to stay competitive. Business transformations require business units to collaborate with information technology (IT) providers to provide the various capabilities necessary to implement the business strategies. Because of the complexities involved in creating and implementing new capabilities, IT portfolio changes must be carefully planned and budgeted.

Capabilities are achieved by implementing a set of requirements, which are submitted by stakeholders to IT programs and then finalized in the context of a release. Such requirements may include a mixture of strategic, tactical and defect support. Unfortunately, current planning tools and frameworks do not provide a strong linkage between the requirements put into place by IT providers and the business strategies originally defined and agreed-to by senior business and technology management during the planning cycle.

For example, during the design or implementation cycle of a new business strategy, a business unit may determine that it needs to provision any number of IT requirements to fulfill the necessary business transformation. Because IT requirements are typically provisioned in “releases” scheduled over time and there are numerous individuals and factors that influence what makes up the IT requirements, over time, it would not be unusual for the business unit to lose sight of the originally business objectives. Unfortunately, there currently exists no framework or toolset for measuring whether a defined set of IT requirements actually align with the agreed-to capabilities that will support the business objectives and strategies of the enterprise. Accordingly, there are currently very limited means for the reporting to management of decisions regarding the “strategic” nature of the IT requirements to be included in a release before development funding has been expended. Without such a tool, management often lacks the necessary data to make informed business and funding decisions.

Thus, a need exists for a process framework and planning toolset that will allow for the analysis of proposed IT requirements to ensure they align with capabilities defined for a proposed business strategy.

### SUMMARY OF THE INVENTION

The present invention addresses the above-mentioned problems, as well as others, by providing a process framework and toolset that will that will allow for the analysis of proposed IT requirements to ensure the proposed requirements align with capabilities defined for a proposed business strategy. The invention consists of a methodology, system and dashboard to enable business transformation strategists, IT business architects and senior management to establish, track and measure alignment of a recognized list of capabilities and IT requirements to the agreed-to business strategy. The invention also includes a set of metrics that measure the alignment of architecture and business requirements to business strategy. These metrics will allow IT providers to maximize delivery of strategic capabilities as part of its portfolio of applications. In addition, the set of metrics will provide IT management with a vehicle to track investments that will keep the IT portfolio aligned with an enterprise technology blueprint.

In a first aspect, the invention provides a business transformation alignment framework, comprising: a data interface system for storing and displaying business transformation data categorized into initiative data, capability data and IT requirement data; a mapping system for mapping between initiative data, capability data and IT requirement data; and a dashboard interface for displaying alignment analysis information regarding how well a set of IT requirements aligns with a capability defined to address a business transformation objective.

In a second aspect, the invention provides a computer program product stored on a computer usable medium for providing business transformation alignment analysis information, comprising: program code configured for storing and displaying business transformation data categorized into initiative data, capability data and IT requirement data; program code configured for mapping between initiative data, capability data and IT requirement data; and program code configured for displaying alignment analysis information regarding how well a set of IT requirements aligns with a capability defined to address a business transformation objective.

In a third aspect, the invention provides a method of providing business transformation alignment analysis information, comprising: providing business transformation data categorized into initiative data, capability data and IT requirement data; displaying the business transformation data in an interface that includes a plurality of views; providing a mapping between initiative data, capability data and IT requirement data; and displaying alignment analysis information regarding how well a set of IT requirements aligns with a capability defined to address a business transformation objective.

In a fourth aspect, the invention provides a method for deploying business transformation alignment analysis toolset, comprising: providing a computer infrastructure being operable to: provide business transformation data categorized into initiative data, capability data and IT requirement data; display the business transformation data in an interface that includes a plurality of views; provide a mapping between initiative data, capability data and IT requirement data; and display alignment analysis information regarding how well a set of IT requirements aligns with a capability defined to address a business transformation objective.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a business transformation alignment toolset in accordance with the present invention.

FIG. 2 depicts a business objective interface view in accordance with the present invention.

FIG. 3 depicts a set of capability interface views in accordance with the present invention.

FIG. 4 depicts a capability/(IT Services View) requirements interface view in accordance with the present invention.

FIG. 5 depicts an application/capability interface view in accordance with the present invention.

FIG. 6 depicts an initiative/capability timeline in accordance with the present invention.

FIG. 7 depicts a transformation plan view in accordance with the present invention.

FIG. 8 depicts an initiate/release alignment interface view in accordance with the present invention.

FIG. 9 depicts a set of dashboard views in accordance with the present invention.

FIG. 10 depicts an initiative dashboard in accordance with the present invention.

FIG. 11 depicts a breakdown dashboard of an initiative in accordance with the present invention.

FIG. 12 depicts a detailed breakdown dashboard of an initiative in accordance with the present invention.

### DETAILED DESCRIPTION OF THE INVENTION

As noted above, successful business transformations depend on a process in which a proposed business strategy drives a set of capabilities, which in turn defines a set of requirements. Requirements are then typically implemented as a series of “releases” that should ultimately deliver the proposed business strategy. Accordingly, while the capabilities satisfy the “wants and needs” of the strategy, the requirements are the actual building blocks that require investment in IT processes, technology and organization. The present invention facilitates the process of ensuring alignment among the “business strategy”, “capabilities” and “requirements” involved in business transformation. The present invention provides a framework and series of tools that allows: (1) a business strategy to be mapped into a set of capabilities; (2) each capability to be mapped into a set of requirements; and (3) the information to be analyzed to determine which initiatives align with a stated business objective. An initiative is a collection of business actions required to achieve a business objective, typically made up of IT components, organizational components, process components, and knowledge components.

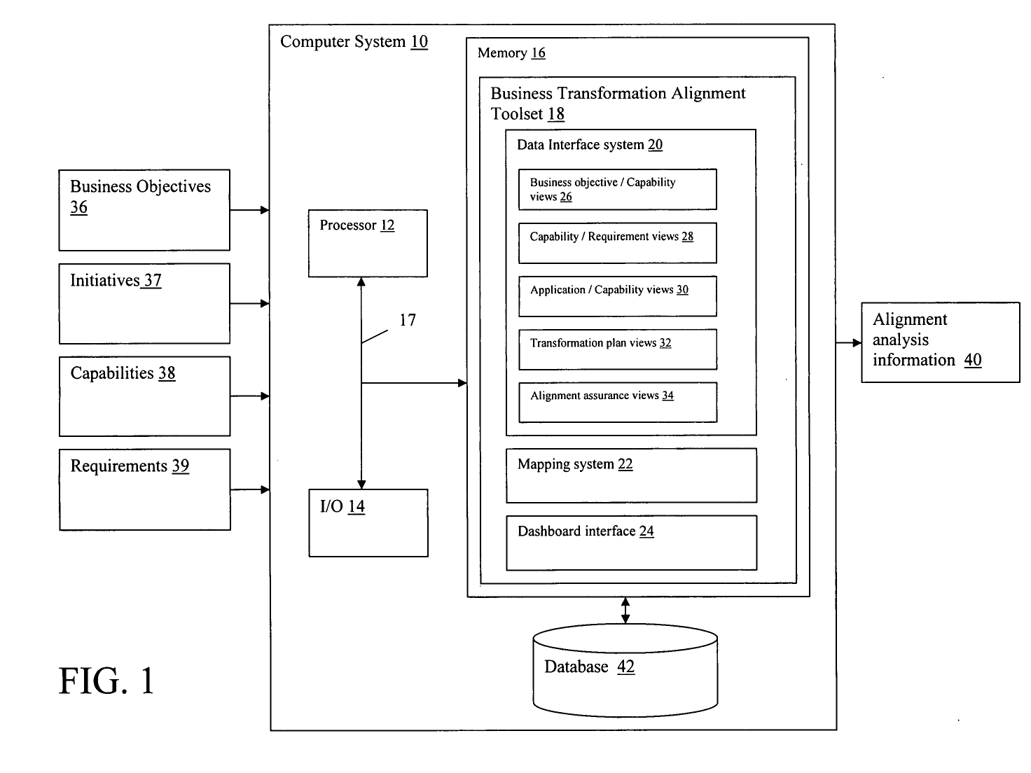

Referring now to drawings, FIG. 1 depicts a computer system 10 having a business transformation alignment toolset 18 that provides alignment analysis information 40 based on inputted business transformation data, including business objectives 36, initiatives 37, capabilities 38 and requirements 39. Business transformation alignment toolset 18 includes: a data interface system 20 that allows business transformation data to be entered and presented in a set of defined views, e.g., in a tabular or spreadsheet format; a mapping system 22 that allows business transformation data to be mapped, e.g., a capability can be mapped to a set of requirements; and a dashboard interface 24 that outputs alignment analysis information 40. Database 42 is also provided to store business transformation data, as well as view definitions for the data interface system 20.

In general, computer system 10 may comprise, e.g., a desktop, a laptop, a workstation, etc. Moreover, computer system 10 could be implemented as part of a client and/or a server. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

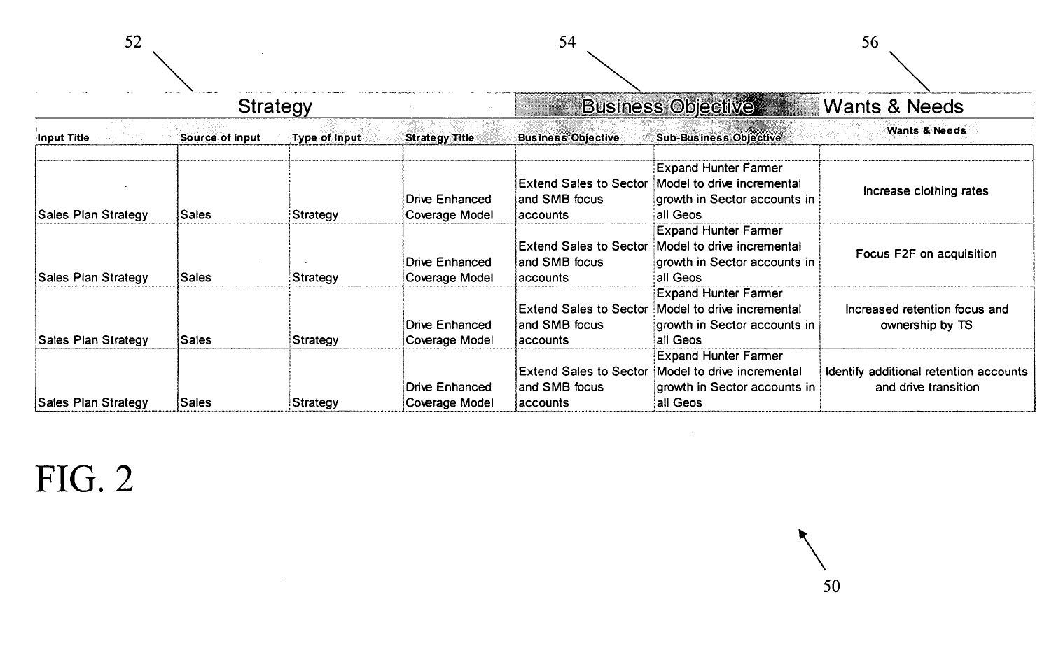

Referring now to FIG. 2, a portion of a first interface view 50 is shown for entering/displaying a business transformation strategy 52 into a set and subset of business objectives 54 and “wants and needs.” In the portion shown, a set of wants and needs 56 is defined for a particular sub-business objective of the strategy 52. In this example, the wants and needs 56 include “Increase clothing rates”, “Focus F2f on acquisition”, etc. This interface view 50 is utilized to define the high level parameters of the desired business transformation.

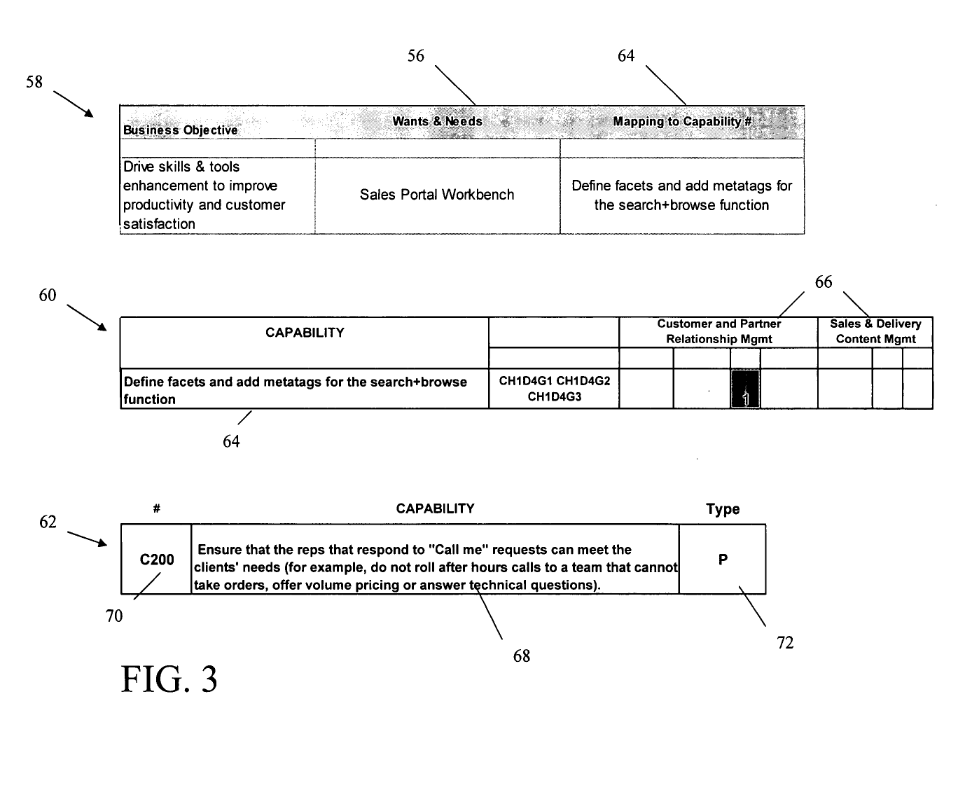

FIG. 3 depicts a next set of interface views 58, 60, and 62 in which a specific wants and needs entry is mapped to a capability 64, as shown in view 58. Once a capability 64 is defined, it can be further mapped, e.g., into one or more business processes 66 that are affected by the capability 64, as shown in view 60. In addition, a capability can be assigned an identifier 70 as a well as a type 72 (e.g., P=policy transformation, T=technical transformation, etc.). This information will identify ‘sweet spots’ of opportunity and drive prioritization of needed capabilities aligned with business strategic value. Overlaps and gaps are identified by inspecting the interface views, which allows business management the ability to re-prioritize and confirm priority and alignment to overall business strategy.

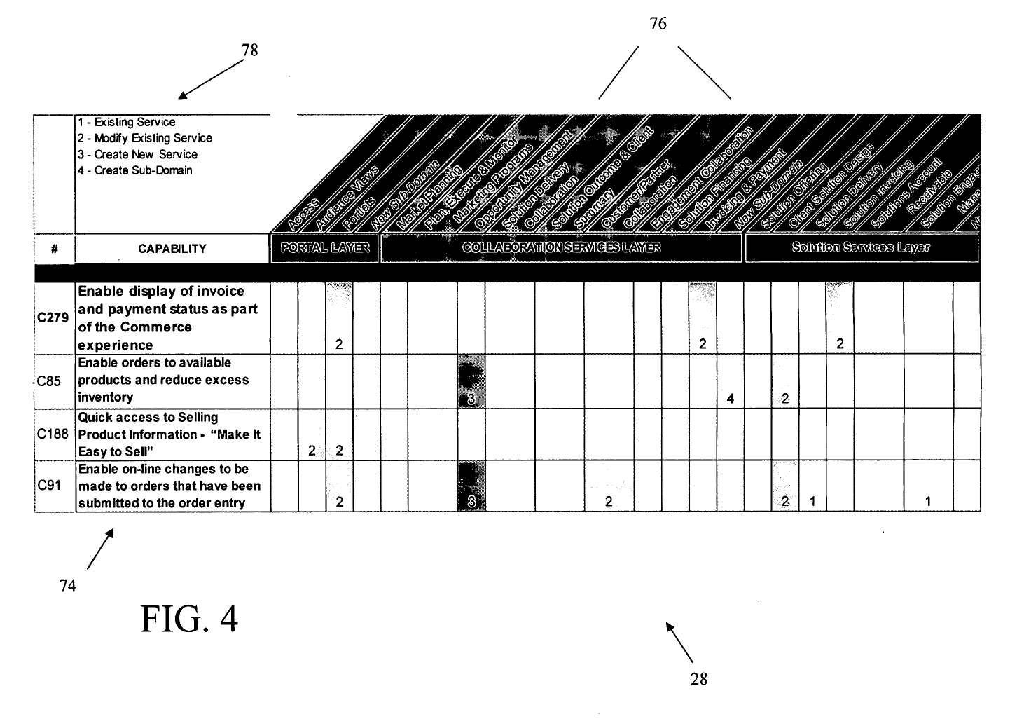

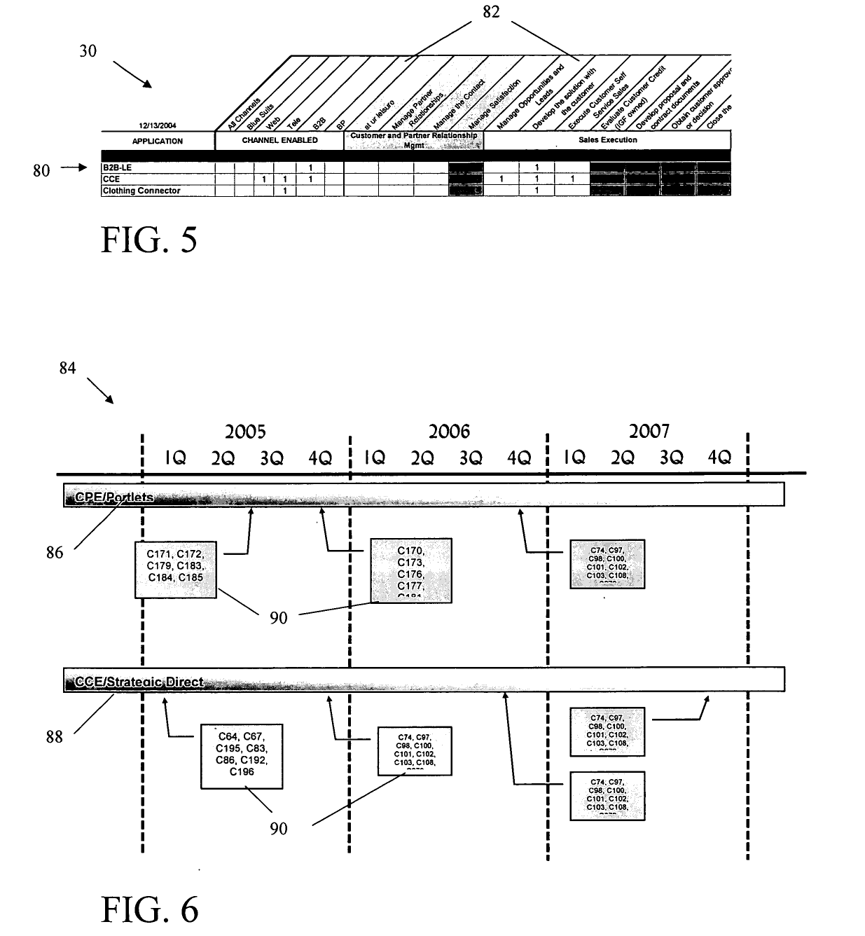

FIG. 4 depicts a capabilities/requirements view 28 in which each defined capability is mapped to a set of required IT services 76. In this example, the IT services 76 are divided into the affected service domains, e.g., Portal Layer, Collaboration Services Layer, Solutions Service Layer, etc. Accordingly, this interface view 28 allows a user to: identify which service domains are affected, identify impacts and gaps on each IT service, establish a target services architecture, determine required market channels, determine value chains supported by capability, assess IT architecture value, etc. Thus, for example, from this view, a user can see which IT services are going to be most impacted by a set of capabilities, and thus allow for the investment of resources to be most effectively utilized. As can be seen, each mapping is given a value 78, where “1” indicates that the IT service already exists; “2” indicates that an existing IT service must be modified, “3” indicates that a new IT service must be created, and “4” indicates that a new sub-domain must be created. FIG. 5 shows an application/capability view 30 in which applications, or IT tools, are mapped to capabilities 82.

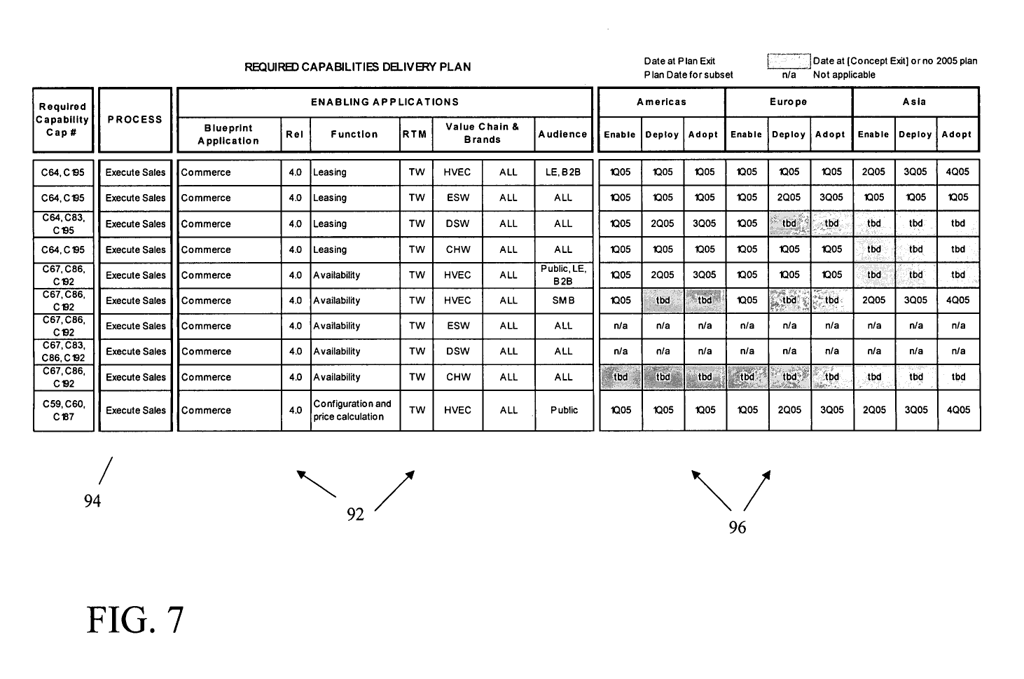

FIG. 6 depicts a timeline view 84 that shows when capabilities 90 for each initiative 86 are scheduled to come on-line. FIG. 7 depicts a transformation plan view 32 that shows funded process and technical initiatives 92 by capability 94, and also includes execution dates 96 for the initiatives. This view measures the execution of the transformation and alignment to strategic drivers and objectives. It thus provides a “big picture” planning view of the funded initiatives, assigns benefit/cost/value to capabilities 94 or groups of capabilities, and also constitutes a baseline of capabilities for a planning cycle.

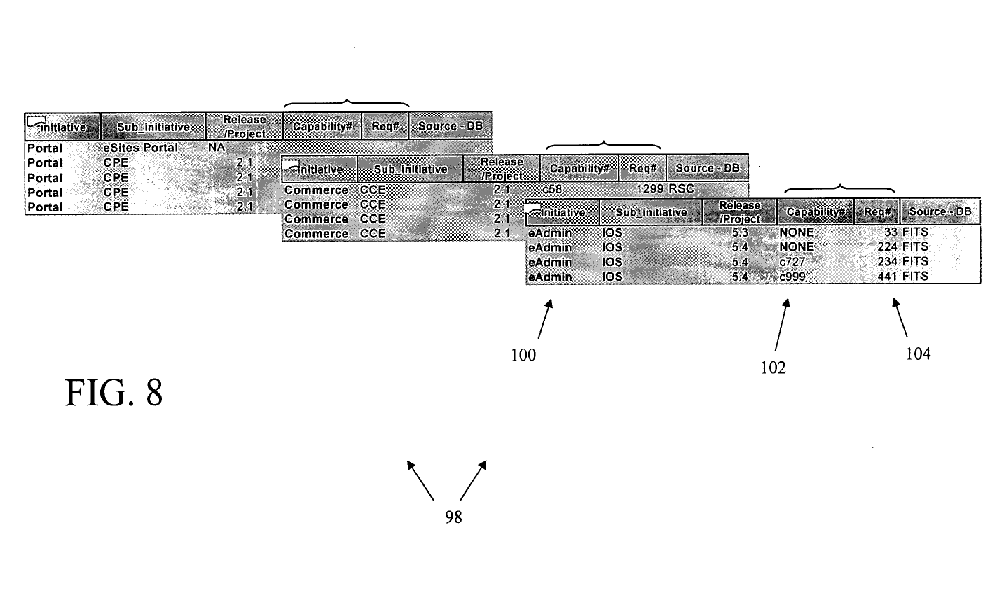

FIG. 8 depicts a release/project view 98 of three initiatives. In this case, each initiative shows the alignment of requirements 104 in release content to strategic capabilities defined during the planning cycle. In this view, the user can see which capabilities 102 are addressed by each release for an initiative 100, and how many requirements 104 are needed to meet the initiative.

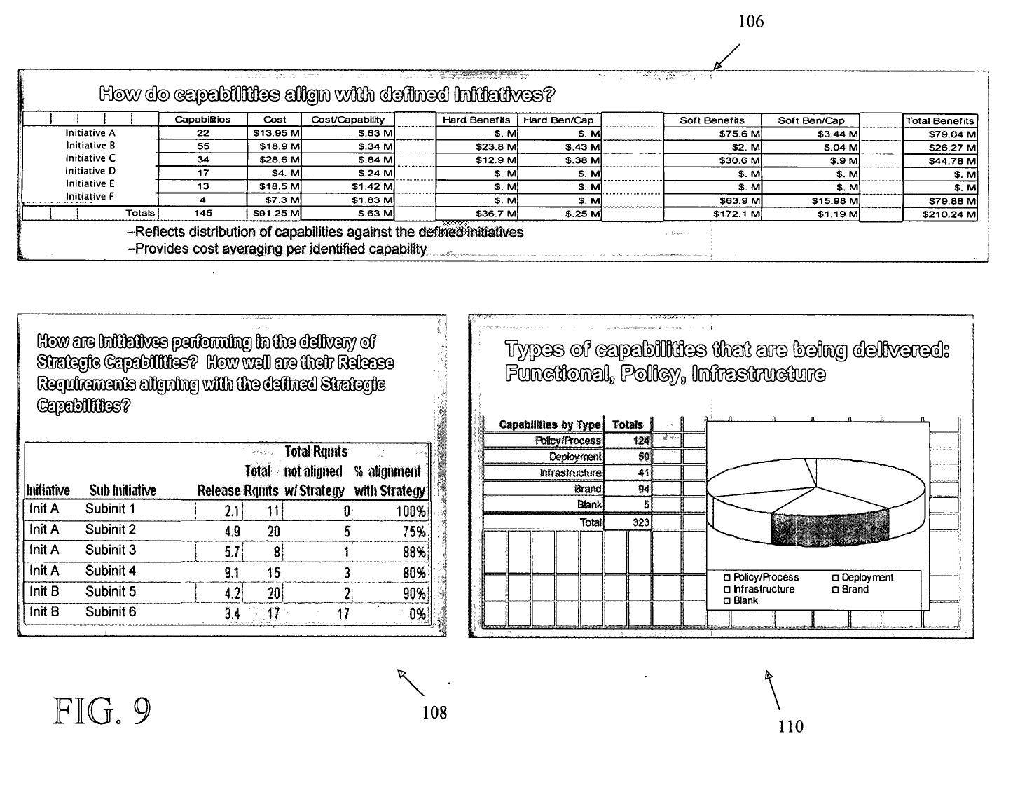

FIG. 9 depicts a dashboard of metrics used to show alignment. A first dashboard 106 is provided to provide cost information by initiative, and for example, provide information such as cost/capability for each initiative. A second dashboard 108 shows which requirements are not aligned with the business strategy for each sub-initiative. A third dashboard 110 shows the number of different capabilities being provided by type.

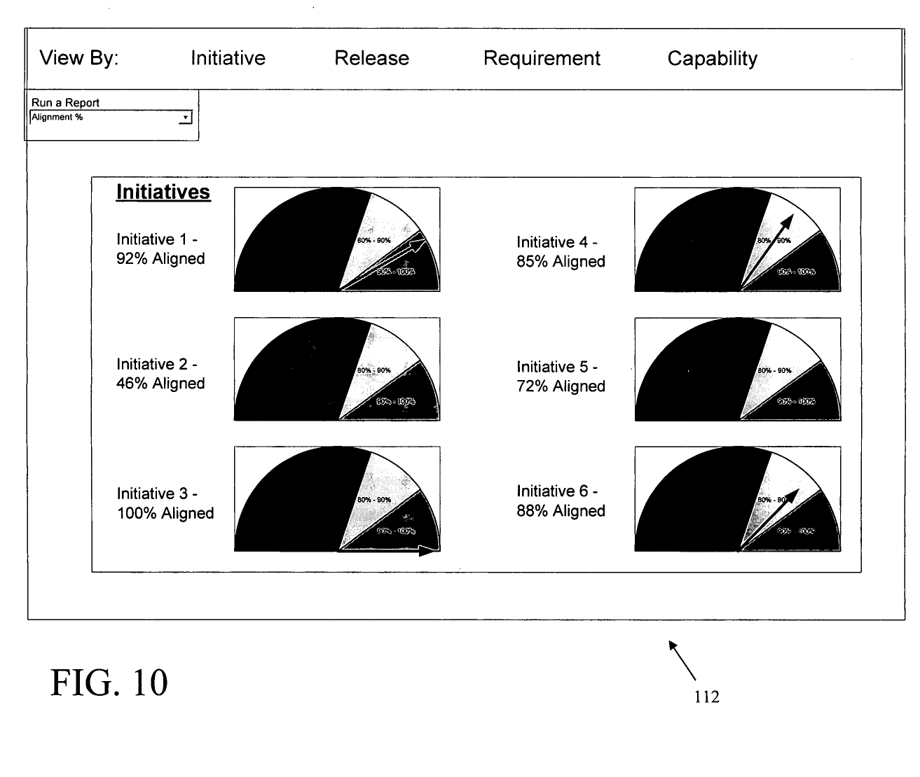

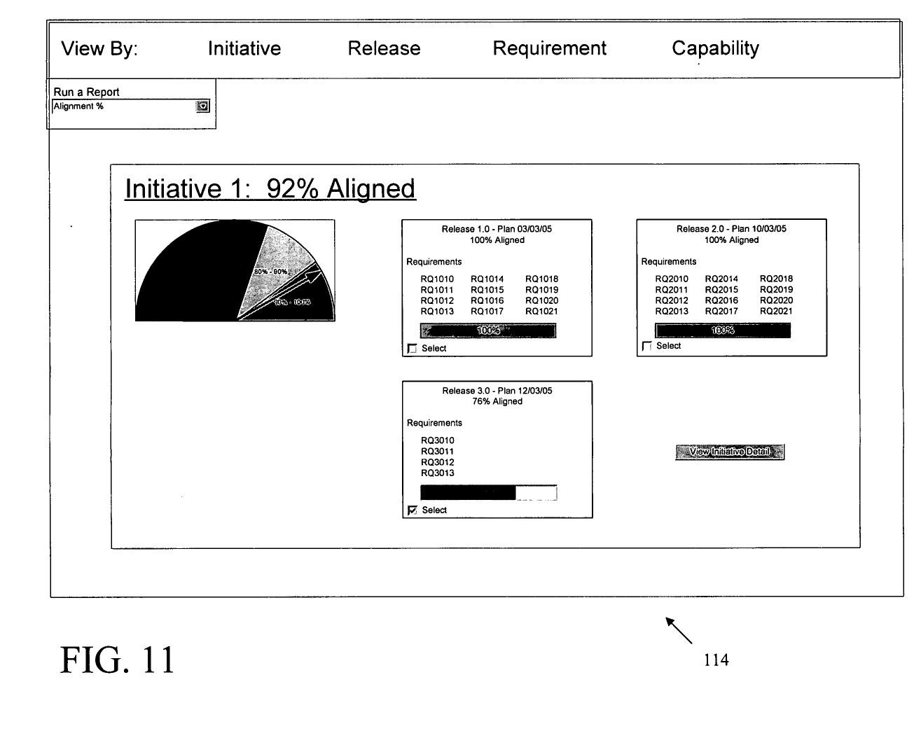

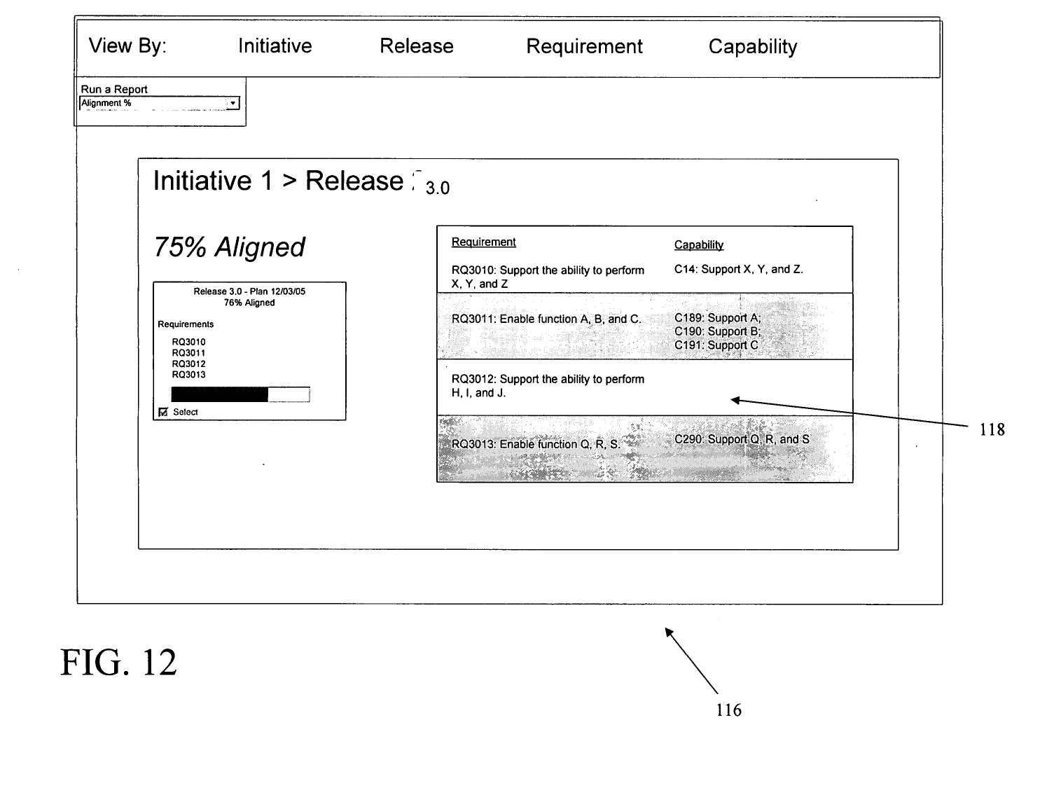

FIG. 10 shows a further dashboard 112 that shows a meter for each initiative that shows how well the initiative is aligned with the original transformation strategy. In this case, it can be seen that initiative 2 is only 46% aligned, while initiative 3 is 100% aligned. FIG. 11 shows a breakdown dashboard 114 of initiative 1 by release. In this case, it can be seen that the requirements of release 1.0 and 2.0 are completely aligned, but release 3.0 is only 76% aligned. FIG. 12 shows a further breakdown dashboard 116 of initiative 1 >release 3.0. In this view, each requirement of the initiative/release is described, as well as the capability or capabilities that the requirement fulfills. As can be seen, the third requirement RQ3012 does not fulfill any capability, thus resulting in an initiative that is only 75% aligned. Obviously, the number and type of views and dashboards provided by the invention could vary without departing from the scope and spirit of the invention.

It should be appreciated that the teachings of the present invention could be offered as a business method on a subscription or fee basis. For example, a computer system 10 comprising business transformation alignment toolset could be created, maintained and/or deployed by a service provider that offers the functions described herein for customers. That is, a service provider could offer to provide a data interface system, mapping system, and dashboard interface, as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A business transformation alignment framework, comprising:
a data interface system for storing and displaying business transformation data categorized into initiative data, capability data and IT requirement data;
a mapping system for mapping between initiative data, capability data and IT requirement data; and
a dashboard interface for displaying alignment analysis information regarding how well a set of IT requirements aligns with a capability defined to address a business transformation objective.

2. The business transformation alignment framework of claim 1, wherein the data interface system includes a graphical user interface configured to display a plurality of views.

3. The business transformation alignment framework of claim 2, wherein a first view provides a spreadsheet type interface for storing and displaying capabilities as a function of IT requirements.

4. The business transformation alignment framework of claim 3, wherein each IT requirement for an associated capability is identified as an existing IT service, an existing IT service that needs to be modified, or IT service that needs to be created.

5. The business transformation alignment framework of claim 2, wherein a second view provides a spreadsheet type interface for storing and displaying a transformation plan arranged by sets of capabilities.

6. The business transformation alignment framework of claim 1, wherein a business transformation is defined by a set of initiatives and each initiative is defined by a set of capabilities.

7. The business transformation alignment framework of claim 6, wherein the dashboard interface displays alignment analysis information regarding how well a set of IT requirements aligns with an initiative.

8. The business transformation alignment framework of claim 1, wherein the alignment analysis information comprises a percentage of how well an initiative is aligned with the business transformation objective.

9. A computer program product stored on a computer usable medium for providing business transformation alignment analysis information, comprising:
program code configured for storing and displaying business transformation data categorized into initiative data, capability data and IT requirement data;
program code configured for mapping between initiative data, capability data and IT requirement data; and
program code configured for displaying alignment analysis information regarding how well a set of IT requirements aligns with a capability defined to address a business transformation objective.

10. The computer program product of claim 9, further comprising a graphical user interface configured to display a plurality of spreadsheet views.

11. The computer program product of claim 10, wherein a first spreadsheet view provides an interface for storing and displaying capabilities as a function of IT requirements.

12. The computer program product of claim 11, wherein each IT requirement for an associated capability is categorized as an existing IT service, an existing IT service that needs to be modified, or IT service that needs to be created.

13. The computer program product of claim 9, wherein a second spreadsheet view provides an interface for storing and displaying a transformation plan arranged by sets of capabilities.

14. The computer program product of claim 9, wherein a business transformation is defined by a set of initiatives and each initiative is defined by a set of capabilities.

15. The computer program product of claim 9, wherein the alignment analysis information is displayed in a dashboard interface that dictates how well a set of IT requirements aligns with an initiative.

16. The computer program product of claim 9, wherein the alignment analysis information comprises a percentage of how well an initiative is aligned with the business transformation objective.

17. A method of providing business transformation alignment analysis information, comprising:
providing business transformation data categorized into initiative data, capability data and IT requirement data;
displaying the business transformation data in an interface that includes a plurality of views;
providing a mapping between initiative data, capability data and IT requirement data; and
displaying alignment analysis information regarding how well a set of IT requirements aligns with a capability defined to address a business transformation objective.

18. The method of claim 17, wherein each of the plurality of views includes a spreadsheet.

19. The method of claim 18, wherein a first view provides an interface for storing and displaying capabilities as a function of IT requirements.

20. The method of claim 17, wherein each IT requirement for an associated capability is categorized as an existing IT service, an existing IT service that needs to be modified, or IT service that needs to be created.

21. The method of claim 17, wherein a second view provides an interface for storing and displaying a transformation plan arranged by sets of capabilities.

22. The method of claim 17, wherein the business transformation data is defined by a set of initiatives and each initiative is defined by a set of capabilities.

23. The method of claim 17, wherein the alignment analysis information is displayed in a dashboard interface that dictates how well a set of IT requirements aligns with an initiative.

24. The method of claim 17, wherein the alignment analysis information comprises a percentage of how well an initiative is aligned with the business transformation objective.

25. A method for deploying business transformation alignment analysis toolset, comprising:
providing a computer infrastructure being operable to:
provide business transformation data categorized into initiative data, capability data and IT requirement data;
display the business transformation data in an interface that includes a plurality of views;
provide a mapping between initiative data, capability data and IT requirement data; and
display alignment analysis information regarding how well a set of IT requirements aligns with a capability defined to address a business transformation objective.
